(19) United States
(12) Patent Application Publication
(10) Pub. No.: US 2003/0179401 A1
(43) Pub. Date: Sep. 25, 2003

(54) Obtaining advanced print functions with a rudimentary print driver

(75) Inventor: Alan K. Robertson, Rochester, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/106,143

(22) Filed: Mar. 25, 2002

(51) Int. Cl. G06F 13/10; G06F 13/00

(52) U.S. Cl. 358/1.14; 358/1.16; 709/321

(57) ABSTRACT

In a low-cost printer context, the standard print driver is typically capable only of continuous flow of document data from the driver to the printers. With the present invention, an algorithm responds to specific events in the driver and diverts data output from the driver to a location in the computer's memory, where the data for the entire document is temporarily accumulated. Post-processing operations are performed on the accumulated data, which is then sent on to the printer. The algorithm allows advanced functions, such as page order reversal and signature making, to be performed with a rudimentary print driver.

### TECHNICAL FIELD

The present invention relates to a print driver, which is software which operates digital printing devices such as ink-jet or laser printers.

### BACKGROUND

Digital printers, typically of the ink-jet or xerographic “laser printer” type, are well known. Digital printers accept digital data relating to a document to be printed, and operate printing hardware to render the desired images relating to the document on paper or other substrate.

With any digital printer, a key piece of software is the “driver,” which in effect bridges the application which holds the document data to be printed (such as, for instance, a word-processing application) to the software which directly operates the printer hardware. Drivers can be of various degrees of sophistication. For low-volume desktop printers, it is usually sufficient to have a driver which takes image data from the word-processing or other application and feeds it to the printer on a largely continuous basis: in such a case, the most common special instruction would be an instruction to start a new page in a multi-page document to be printed.

In some situations, however, more sophisticated functions of a driver are desirable. One such function is known as “page order reversal.” The most simple printer hardware typically outputs pages face-up: when a multi-page document is printed, the first page of the document emerges from the printer first, but subsequent pages are caused to stack up on the each other, so the final stack of output sheets will be in the reverse of the intended order. Page order reversal causes the document to be output by the printer hardware last page first, so that the final stack of sheets is in the correct page order. Another useful function is signature making, wherein page images of a multi-page document are placed in predetermined positions on the output sheets so that the sheets can be folded together to make a booklet. Both page order reversal and signature making typically require an electronic accumulation of all page images in a print job (such as, for example, to determine what is the last page of the job) before image-related data can be sent to printer hardware.

While page order reversal and signature making are well-known features in sophisticated print drivers, they tend to be beyond the capability of inexpensive rudimentary print drivers. The present invention is directed to techniques by which these and other advanced features can be obtained from a rudimentary print driver.

### SUMMARY OF THE INVENTION

According to one aspect of the present invention, there is provided a method of operating a print driver using a StartDoc( ) function, comprising overwriting a value of a pointer associated with the StartDoc( ) function with a filename associated with a memory location.

### BRIEF DESCRIPTION OF THE DRAWINGS

FIG. 1 is a diagram showing the function of a print driver in a basic computer-to-printer setup.

FIG. 2 is a flowchart showing steps in one practical embodiment of the invention.

FIG. 3 is a flowchart showing the steps of the flowchart of FIG. 2, in the context of performing post-processing on document data output from a print driver.

### DETAILED DESCRIPTION

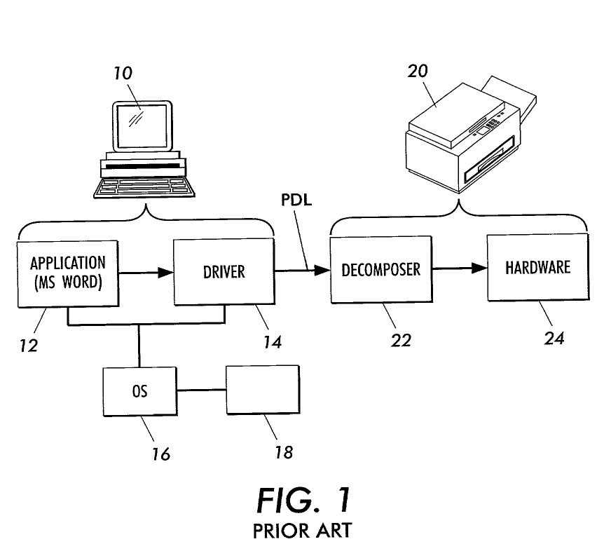

FIG. 1 is a diagram showing the function of a print driver in a basic host-computer-to-printer setup as generally known in the art. In the basic setup, a host computer 10 sends a job to be printed to a printer 20, which is typically of an inkjet or xerographic “laser printer” type. The computer 10 includes an application 12 which originates and retains data for the job to be printed; typical applications in this context include Microsoft® Word™ or PowerPoint™. When printing of, for example, a Word document is desired, the data forming the document in Word is sent to a driver 14. As is known, the driver 14 takes the document data and converts it to a “page description language” (PDL) or equivalent format, for sending to printer 20. In this context, the most common output formats for a driver 14 are page description languages such as PCL or Adobe® PostScript™, or TIFF. The application 12 and driver 14 run on the computer's operating system 16, and as such will have access to some memory 18 within the computer. The driver 14 sends the output data to, in this embodiment, a Windows® Print Spooler Service (not shown), which then uses a network driver, parallel port driver, USB driver, etc. to transfer the data to the printer 20.

The printer 20 includes a decomposer or interpreter 22, which converts the data from its PDL or other format into a series of signals which are generally directly operable of printer hardware 24, which may include, for instance, a modulating laser or a set of ink-jet ejectors.

As mentioned above, a basic low-cost driver 14 is typically capable of only substantially continuous flow of image-related data to printer 20: the data it outputs starts at the top of page 1 of the document to be printed and in effect moves downward through a series of pages to be printed, with markers in the data indicating an instruction to start another page. This continuous flow of image-related data to the printer 20 is incompatible with advanced printer function such as page order reversal and booklet making. In these and other cases, it is usually necessary that all of the page image data output by the driver be accumulated in a memory before being sent to printer 20.

The following description relates to a practical embodiment, in which a relatively rudimentary “mini-driver” which is available with the Microsoft® Windows™ NT4 or Windows™ 2000 operating systems, can be modified with additional code interacting therewith. The effect of the method is that, when the mini-driver such as 14 is caused to output data, the data is diverted from its usual path to printer 20 and instead directed to a reserved temporary file, such as in memory 18 of computer 10. Once all the data for a given print job is collected in the temporary file, certain actions (“post-processing”) can be taken with the data, such as page order reversal or signature making. Later the data retained in memory 18 is sent to printer 20 via the Windows® Print Spooler service, possibly in a more desirable form, such as in reverse page order.

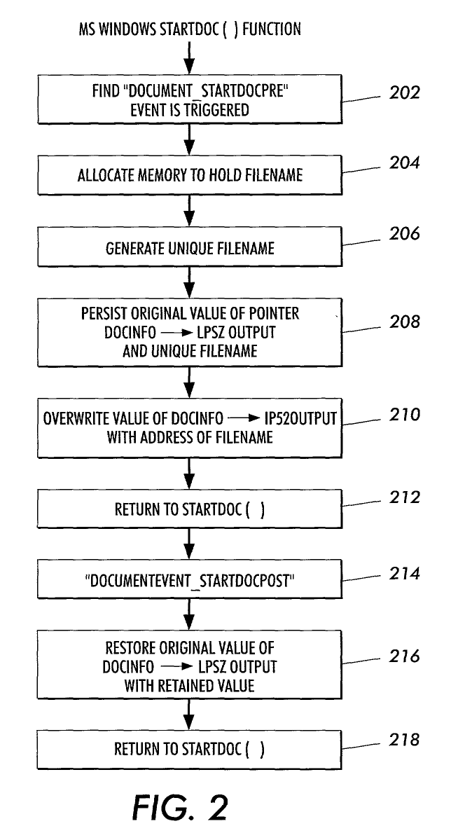

The method described in FIG. 2 represents an algorithm which reacts with the above-mentioned operating systems. Specifically, the method interacts with calls relating to an API function called StartDoc( ), which a Windows® application invokes to initiate a print job.

StartDoc( ) results in the print driver 14 receiving two “events” to which it may respond. These events are DOCUMENTEVENT_STARTDOCPRE and DOCUMENTEVENT_STARTDOCPOST. Both events are received through the callback function, DrvDocumentEvent( ), which is documented in the Microsoft® Driver Development Kit (DDK) documentation. DOCUMENTEVENT_STARTDOCPRE is called before the underlying implementation of StartDoc( ) is executed within the operating system. DOCUMENTEVENT_STARTDOCPOST is called after that code is executed, but before control is returned to the application. The application's DOCINFO structure is directly available to each of these events. The flowchart of FIG. 2 shows how detection of these events causes the algorithm to operate the driver in certain ways.

Initially, the StartDoc( ) function is running in the driver 14. At one point, incidental to request for a print job, the DOCUMENTEVENT_STARTDOCPRE event invokes the algorithm (step 202). In response, the algorithm allocates memory, such as in memory 18, to hold an arbitrary filename (step 204), and then generates a unique filename useable by the operating system (step 206). This filename will be used as location for the “diverted” print data from driver 14.

Within the StartDoc( ) function, when the system is operating in its normal manner, memory is allocated for what is called a DOCINFO structure, and a parameter called IpszOutput is associated with the structure. If IpszOutput is left blank (NULL), then the job is simply sent to the printer associated with the device context. But, if a valid filename appears here, the Windows™ operating system redirects the job's PDL to that file instead of sending it to the printer. (This is how the “Print to File” feature works in Microsoft® applications.)

Returning to FIG. 2, the original value of the pointer docinfo->IpszOutput is persisted, along with the above-created filename, for later use (step 208). Then the value of the pointer docinfo->IpszOutput is overwritten with the filename (step 210) and the operation of StartDoc( ) resumes (step 212). The underlying implementation acts upon this modified version of docinfo, rather than the application's original one. What has occurred, in effect, is that the image data usually intended for direct sending to the printer is redirected to the location in memory pointed to by the new filename.

Later in the StartDoc( ) operation, the event DOCUMENTEVENT_STARTDOCPOST occurs. When this event is detected (step 214), the value of docinfo->IpszOutput is overwritten (that is, restored) with the value that was retained earlier in the process (step 216).

The final result of the modification of StartDoc( ) caused by the FIG. 2 algorithm is that the output data from driver 14 is retained in a special file in the memory 18. While the data is in the file, post-processing steps, such as to facilitate page order reversal, can be performed on the accumulated data. The actual post-processing is initiated in response to another event, DOCUMENTEVENT_ENDDDOCPOST, which is a result of the application's invocation of the EndDoc( ) API. An application calls EndDoc( ) to indicate that it has completed rendering all of the data for the current print job.

In a practical embodiment, the events described are not typically available to a commercially available mini-driver. Access is obtained to these events by a “wrapper” or “filter” DLL (dynamic linked library). The custom DLL is installed in such a manner to receive every function call that would otherwise be destined for the corresponding mini-driver component. The wrapper DLL contains a “stub” for every function in the corresponding mini-driver component; most of these stubs simply act as a proxy and defer processing to the corresponding function in the corresponding mini-driver component. However, one key stub function in the wrapper DLL is used to intercept the events used by the FIG. 2 algorithm. The original value of docinfo->IpszOutput and the name of the temporary filename must be persisted carefully, particularly in a multi-threaded or multi-tasking environment. A useful tool to carry out this persistence is a Windows®-provided mechanism called “printer escapes.” A printer escape allows an arbitrary block of data to be sent to the print driver's PDL rendering engine.

In order to install software which interacts with a pre-existing mini-driver and causes it to operate according to the FIG. 2 flowchart, the installation script used to install the mini-driver is modified. In the Windows® NT4 or 2000 case, the entry called “ConfigFile=” ordinarily points to a core Microsoft® supplied DLL; with a mini-driver modified to carry out the algorithm of FIG. 2, the entry will instead point to a new DLL, typically the “wrapper” DLL as described above. In broad terms, the wrapper DLL has a capability of “inspecting” events from an API while a function occurs.

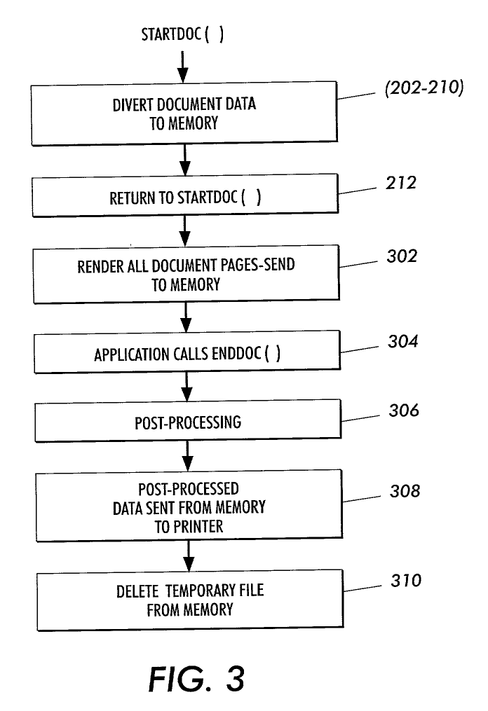

FIG. 3 is a flowchart showing the steps of the flowchart of FIG. 2, in the broader context of performing post-processing on document data output from a print driver; certain steps from FIG. 2 are summarized in FIG. 3. In the course of sending a print job from a computer 10 to a printer 20, the StartDoc( ) function is invoked. According to the embodiment of FIG. 2, certain calls within StartDoc( ) are detected and used to divert data which is ordinarily intended for direct transfer to the printer to a declared memory 18 operated by the operating system of the computer, such as shown by steps 202-210 in FIG. 2. The functions of the algorithm then return to StartDoc( ) (step 212, as in FIG. 2 as well), and, because of the diversion, all the document page images rendered by the driver are sent to the memory location (step 302). Once all the data associated with the job is thus accumulated in the memory, the application them makes an EndDoc( ) call (step 304). Then, post-processing steps such as generally indicated as 306 can be taken on the data, such as to facilitate advanced functions such as page order reversal or signature making. When post-processing is complete, the print driver sends the accumulated data to the printer via the Windows® Print Spooler service and eventually to the printer (step 308). Finally, in a clean-up step 310, the document data is then deleted from the memory location.

1. A method of operating a print driver using a StartDoc( ) function, comprising:
overwriting a value of a pointer associated with the StartDoc( ) function with a filename associated with a memory location.

2. The method of claim 1, further comprising
generating a unique filename to be associated with the memory location.

3. The method of claim 1, further comprising
detecting a DOCUMENTEVENT_STARTDOCPRE event; and
initiating the overwriting step in response to said detecting step.

4. The method of claim 1, further comprising
overwriting an original value of docinfo->IpszOutput with data relating to a memory location.

5. The method of claim 4, further comprising
detecting a DOCUMENTEVENT_STARTDOCPOST event; and
following detecting the DOCUMENTEVENT_STARTDOCPOST event, restoring the original value of docinfo->IpszOutput.

6. The method of claim 1, further comprising
directing document-related data output by the print driver to a predetermined memory location.

7. The method of claim 6, further comprising
performing a post-processing operation on document-related data retained at the memory location.

8. The method of claim 7, the post-processing operation relating to page order reversal.

9. The method of claim 7, the post-processing operation relating to signature making.
